(19) United States
(12) Patent Application Publication
(10) Pub. No.: US 2006/0177081 A1
(43) Pub. Date: Aug. 10, 2006

(54) Data transmission device for wireless data transmission for hearing devices and corresponding method

(75) Inventors: Robert Bauml, Eckental (DE); Uwe Rass, Nurnberg (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Audiologische Technik GmbH

(21) Appl. No.: 11/343,393

(22) Filed: Jan. 31, 2006

(30) Foreign Application Priority Data
Feb. 7, 2005 (DE) 10 2005 005 603.2

(51) Int. Cl. H04R 25/00

(52) U.S. Cl. 381/315

(57) ABSTRACT

ITE devices should also be accessible in a simple manner via further transmission paths. A converter unit with a high-frequency receive device is thus proposed for receiving high-frequency signals from an external transmit unit, said converter unit further comprising a mixing unit for mixing the high-frequency signal with a reference signal of a similarly high frequency, so that an output signal can be generated, the frequency of which is lower by at least one order of magnitude and is suited to inductive transmission. A transmit device for inductive transmission of the output signal to a hearing device is provided in the converter as an output.

### CROSS REFERENCE TO RELATED APPLICATIONS

This application claims priority to the German Application No. 10 2005 005 603.2, filed Feb. 7, 2005 which is incorporated by reference herein in its entirety.

### FIELD OF INVENTION

The present invention relates to a data transmission device for wireless data transmission to a hearing device with a high-frequency receive device for receiving high-frequency signals from an external transmit unit. Furthermore, the present invention relates to a corresponding method for wireless data transmission. The term ‘data’ is used here primarily for coded audio signals and voice signals.

### BACKGROUND OF INVENTION

In principle there are two possibilities for the wireless transmission of digital signals to a hearing device; the high-frequency (HF) far field transmission and the inductive near field transmission. Both variants have advantages and disadvantages. The high-frequency transmission usually takes place in the range of 800 to 1000 MHz, whereas the inductive transmission takes place in the range of 1 to 30 MHz. The coverage for hearing device applications lies at approximately 10 m with high-frequency transmission and only at 1 m with inductive transmission. Particular disadvantages with high-frequency transmission are that the absorption of electromagnetic signals in the body, the dimensions for the antenna and the power draw of the receiver are considerable. In contrast, with signals for inductive transmission, the absorption in the body is minimal and the dimensions of an induction coil for the transmission and the power draw of the receiver are small.

### SUMMARY OF INVENTION

The size of the components and the high power draw both result in the high-frequency transmission only being applicable in large hearing devices (BTEs). For this reason the coverage is sufficient for typical applications. The inductive transmission can also be implemented in the smallest hearing devices in the auditory canal (CICs), but for this reason has a restricted coverage. For the purpose of the transmitter, two systems have been needed to date in order to cover all hearing device designs.

The problem of coverage with inductive transmission can be resolved by using a converter. The most obvious implementation of the converter contains the demodulation of the received high-frequency signal and the renewed modulation for transmission via the inductive transmission path. This involves a relatively large switching outlay for the converter unit, but also a delay during transmission. A device of this type is known for instance from the company GN ReSound. It serves to receive Bluetooth signals and to convert said signals into analog signals which are transmitted to a hearing system and/or its telephone coil with the aid of an induction coil. In this case it is necessary to demodulate and decode the present signals corresponding to the Bluetooth standard, in order to subsequently convert them into analog signals.

Furthermore only solutions for transmitting analog radio signals to the hearing device have been available to date on the market. In this case however, systems with external units also exist which also receive digital radio signals, these are however transmitted to the BTE hearing device by means of an analog FM link. The hearing device then requires an FM receiver, which is usually attached.

Publication EP 1 460 769 A1 further discloses a mobile transceiver for hearing devices. In this case, the signals are emitted using a frequency other than that with which they were received, in order to avoid interferences.

Furthermore, publication U.S. Pat. No. 4,920,570 discloses a control system of a modular design. In this case, each input module transmits the signals to a switching module either in analog or digital form. Optionally high-frequency, ultrasound, infrared or inductive transmission can be selected. U.S. Pat. No. 5,721,783 further discloses a hearing device, located in the auditory canal, which has an external processor unit. A bidirectional link between both units is set up by means of a microwaves or radar waves.

Publication DE 100 15 421 C2 discloses a hearing system comprising an external transmission unit and an implanted receive device. The transmission unit worn on the head near to the ear comprises a high-frequency transmitter/receiver for receiving and demodulating a signal of a telecommunication network and a bidirectional telemetry interface for inductive transmission to the implanted receive device. This allows a data transmission to take place between the telecommunication network, the transmission unit and the implanted receive device.

An object of the present invention is thus to be able to achieve, in a simple manner, wireless transmission of high coverage even with very small devices.

According to the invention, this object is achieved by a data transmission device for wireless data transmission to a hearing device with a high-frequency receive device for receiving a high-frequency, modulated signal from an external transmit unit, a mixing device for mixing the high-frequency modulated signal with a reference signal of a similarly high-frequency, so that a modulated output signal can be generated, the carrier frequency of which is lower by at least one order of magnitude and is suitable for inductive transmission and a transmit device for inductive transmission of the output signal to the hearing device. The general principle of mixing signals is known from “Nachrichtenübertragung” [Message transmission], Kammeyer Karl Dirk, Teubern Verlag 1992, in particular page 264.

Provision is similarly made in accordance with the invention for a method for wireless data transmission to a hearing device by receiving a high-frequency, modulated signal from an external transmit unit, mixing the high-frequency, modulated signal with a reference signal of a similarly high-frequency, so that a modulated output signal is generated, the carrier frequency of which is lower by at least one order of magnitude and is suitable for inductive transmission, and inductive transmission of the output signal to the hearing device.

The advantage of the data transmission device according to the invention or the method for wireless data transmission according to the invention is that they can be implemented using very simple means. Furthermore, the possibility hereby exists of enabling digital data transmission for all hearing device designs using one single transmitter type. The ITE devices of a small design can now also be reached across larger distances by radio by means of the inventive relay station. The proposed conversion method further results in a minimal delay time over the complete transmission path, since a demodulation and a decoding as well as a renewed modulation and coding can be completely dispensed with. This point is paramount, particularly for the audio transmission, e.g. with television.

The high-frequency signal preferably exhibits a frequency above 800 MHz and the output signal a frequency below 30 MHz. High-frequency transmission is thus possible on the input-side and inductive transmission on the output-side.

In a particularly preferred embodiment, the high-frequency receive device exclusively consists of an antenna, a filter and an amplifier. Similarly, the transmit device should exclusively consist of a filter, a power amplifier and a transmit coil. The complete data transmission device or conversion unit can be designed using very simple means.

The type of modulation in the high-frequency receive signal and in the output signal is favorably identical. This results in no time delays during a demodulation and a remodulation.

The type of coding in the high-frequency receive signal and in the output signal should be identical. The omission of a decoding and recoding gives rise to temporal advantages. In other words, the coding of the digital input signal remains unchanged, so that a digital output signal with the same coding results.

### BRIEF DESCRIPTION OF THE DRAWINGS

The present invention is described in more detail below with reference to the appended drawings, in which;

FIG. 1 shows a block diagram of a converter according to the invention and

FIG. 2 shows a schematic transmission path for BTE devices and ITE devices.

### DETAILED DESCRIPTION OF INVENTION

The embodiments described in more detail below represent preferred exemplary embodiments of the present invention.

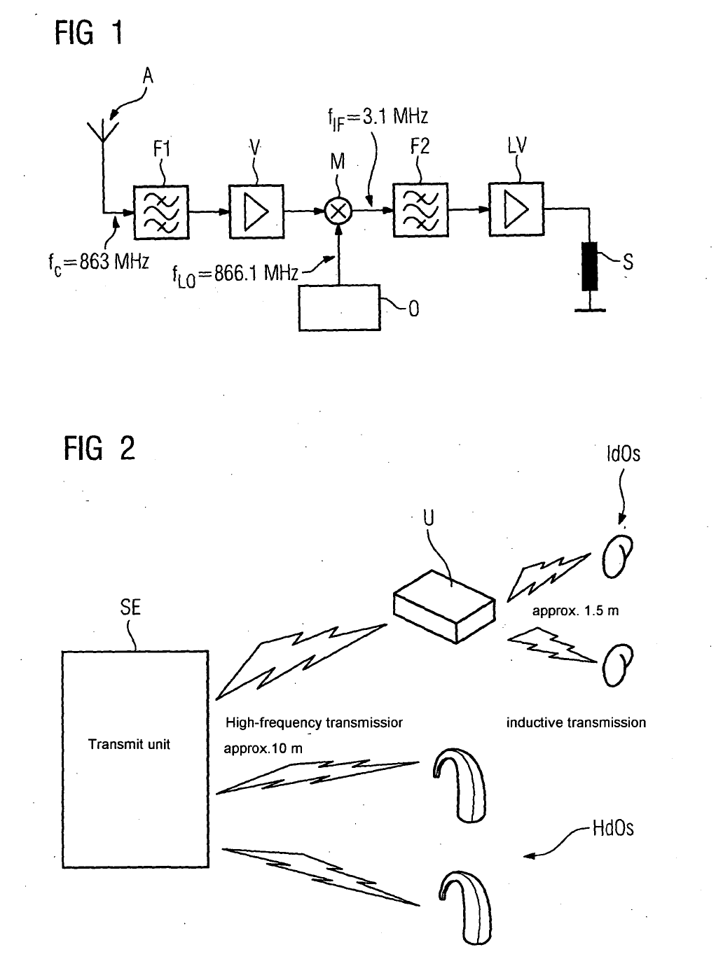

A converter according to the invention, i.e. a data transmission device according to the invention consists according to FIG. 1 for instance of an antenna A which serves as a receive antenna for high-frequency signals. In the present example, the antenna A receives an input signal of the frequency 863 MHz. The antenna A is arranged downstream of a filter F1. The filtered input signal is routed to a mixer M by means of an amplifier V. The amplified input signal is mixed in the mixer M with a predetermined alternating voltage of an oscillator O. In the present case, the oscillator voltage has a frequency of 866.1 MHz.

The mixing results in a spectral component with a differential frequency resulting, in the present case, in a frequency of 3.1 MHz at the output of the mixture. The output signal of the mixer M is in turn filtered in a filter F2 and routed to a power amplifier LV. The output signal of the power amplifier LV is then fed into the transmit coil S, which transmits it to a telephone coil of a hearing device by means of inductive transmission.

The high-frequency signal of more than 800 MHz is thus mixed down in the converter to an intermediate frequency below 30 MHz, so that the resulting signal lies at the desired carrier frequency for the inductive transmission. In this case, demodulation and remodulation, as well as decoding and recoding do not take place. In the case of a digital input signal, the output signal of the converter also remains digital. In this case, the digital output signal of the converter is thus inductively transmitted to the hearing device.

The advantage of the present invention is now apparent from FIG. 2. An analog or digital signal is directly transmitted across a distance of 10 m for instance from a transmit unit SE to large hearing devices (BTEs) by means of high-frequency transmission. The relatively large high-frequency receiver can be accommodated in each instance in a BTE device. No converter unit is needed for the transmission.

The same transmit unit SE can now also be used to supply smaller hearing devices (ITEs) in a range of 10 m. For this purpose, the transmit unit SE first transmits the message by high-frequency transmission to a converter U. This is designed according to the block diagram in FIG. 1. This allows an inductive output signal to be generated which has coverage of 1.5 m and is accommodated by the ITE devices. For this purpose, the ITE devices exhibit corresponding inductive receivers.

The hearing aid wearer preferably wears the converter U on his/her body. The ITE devices can thereby also always be supplied with radio signals, the source of which lies outside the coverage of inductive transmission.

1.-10. (canceled)

11. A data transmission device for wireless data transmission to a hearing device, comprising:
a high-frequency receiver for receiving a high-frequency modulated signal from an external transmitter;
a signal mixing unit for mixing the high-frequency modulated signal with a reference signal having essentially the same high-frequency as the high-frequency modulated signal for generating a modulated output signal having a carrier frequency which is lower by at least one order of magnitude compared to high-frequency modulated signal, the modulated output signal configured for inductive transmission; and
a transmitter for inductive transmission of the modulated output signal to the hearing device.

12. The data transmission device according to claim 11, wherein the high-frequency modulated signal has a frequency above 800 MHz, and the modulated output signal has a frequency below 30 MHz.

13. The data transmission device according to claim 11, wherein the high-frequency receiver consists of an antenna, a first filter and an amplifier.

14. The data transmission device according to claim 11, with the transmitter consists of a second filter, a power amplifier and a transmitter coil.

15. The data transmission device according to claim 11, wherein the high-frequency modulated signal and the modulated output signal include an identical modulation type.

16. The data transmission device according to claim 11, wherein the high-frequency modulated signal and the modulated output signal include an identical type of coding.

17. A method of wirelessly transmitting data to a hearing device, comprising:
receiving a high-frequency modulated signal from an external transmitter;
mixing the high-frequency modulated signal with a reference signal having essentially the same high-frequency as the high-frequency modulated signal for generating a modulated output signal having a carrier frequency which is lower by at least one order of magnitude compared to high-frequency modulated signal, the modulated output signal configured for inductive transmission; and
inductively transmitting the modulated output signal to the hearing device

18. The method according to claim 17, wherein the high-frequency modulated signal has a frequency above 800 MHz, and the modulated output signal has a frequency below 30 MHz.

19. The method according to claim 17, wherein the high-frequency modulated signal and the modulated output signal include an identical modulation type.

20. The method according to claim 17, wherein the high-frequency modulated signal and the modulated output signal include an identical type of coding.
